(19) United States
(12) Patent Application Publication
(10) Pub. No.: US 2016/0202796 A1
(43) Pub. Date: Jul. 14, 2016

(54) METHOD FOR CHARACTERIZING AN OBJECT OF INTEREST BY INTERACTING WITH A MEASURING INTERFACE, AND DEVICE IMPLEMENTING THE METHOD

(71) Applicant: FOGALE NANOTECH, Nîmes (FR)

(72) Inventors: Bruno LUONG, Nimes (FR); Sylvain PETITGRAND, Caissargues (FR); Clement BONNERY, Nimes (FR)

(21) Appl. No.: 14/897,532

(22) PCT Filed: Jun. 4, 2014
(86) PCT No.: PCT/EP2014/061627

§ 371 Date: Mar. 17, 2016

(30) Foreign Application Priority Data
Jun. 11, 2013 (FR) 1355370

(51) Int. Cl. G06F 3/044; G06F 3/041; G06F 3/0354

(52) U.S. Cl. CPC G06F 3/044; G06F 3/03545; G06F 3/0416; G06F 2203/04106

(57) ABSTRACT

The present invention relates to a method for characterizing an object of interest (1) by interacting with a measuring interface (2), comprising steps for (i) acquiring a spatial distribution of measurements representative of the distance (3) between the object of interest (1) and a plurality of measuring points of the measuring interface (2), (ii) determining an estimated position of the object of interest (1) relative to the measuring interface (2), and (iii) determining at least one additional characteristic of the object of interest from among a dimensional characteristic and an angular positioning characteristic (8, 23) relative to the measuring interface (2). The invention also relates to an interface device and an apparatus implementing the method.

### TECHNICAL DOMAIN

The present invention concerns a method for characterizing an object of interest in interaction with a measurement interface, which allows information about the dimension and/or the angular position of the object to be determined.

The domain of the invention is more particularly but not limited to that of tactile and contactless man-machine interfaces.

### STATE OF THE PRIOR ART

Numerous communication and work apparatuses utilize tactile or contactless measurement interfaces as man-machine interface for entering commands. Said interfaces can in particular take the form of pads or touchscreens. They are found for example in mobile telephones, smart phones, computers with touchscreen, pads, PCs, mice, touchpads and giant screens, etc.

Said interfaces frequently use capacitive technologies. The measurement surface is equipped with conductive electrodes connected to electronic means which make it possible to measure the variation of capacitances appearing between the electrodes and the object to be detected in order to perform a control.

It is possible to produce transparent electrodes that allow an interface to be superimposed on a display screen, for example a smart phone.

Most of said interfaces are tactile, i.e. they can detect the contact of one or more objects of interest or control (such as fingers or a stylus) with a surface of the interface.

Gesture interfaces or contactless interfaces are increasingly being developed, which are capable of detecting control objects at a greater distance from the interface, without contact with the surface.

The development of contactless interfaces requires the implementation of highly sensitive capacitive measurement techniques, and offering a high degree of immunity to environmental disturbances. Indeed, the capacitance that is created between capacitive measurement electrodes of the interface and control objects is inversely proportional to the distance separating them.

Known for example is document FR 2 756 048 of Rozière which discloses a capacitive measurement method which makes it possible to measure the capacitance and distance between a plurality of independent electrodes and an object in proximity.

Said technique enables capacitance measurements to be obtained between the electrodes and the objects with high resolution and sensitivity, making it possible for example to detect a finger at a distance of several centimeters, even up to 10 cm. The detection can be done in space in three dimensions, but also on a surface, called measurement surface.

Conventionally, the information sought and exploited by contactless interfaces is limited to the localization in space of the control object. The measurements furnished by the sensors are analyzed to determine an equivalent or average position of said control object, for example in the form of a point of coordinates (x, y, z) in space, and/or a point of coordinates (x, y) on a surface or a plane of reference of the measurement interface.

For certain applications, it can be useful to obtain additional information about the control object, such as its angular position relative to the measurement surface, or a dimension. Now, this information is not generally available with current interfaces.

Knowledge of this information can make it possible to enhance the information transmitted to the man-machine interface concerning the user's gesture, for example to improve the precision of its detection.

Moreover, some control interfaces (for example of smart phones or tablets) are designed to allow the input of commands with a finger or a stylus. In this case the stylus is used for precise actions, such as writing. When it is necessary to distinguish the actions of fingers and the stylus (which for example can correspond respectively to commands and two hand writing or drawing), active stylus technologies must be used.

There is therefore a need for a detection method which makes it possible to identify the object used, in such a way for example as to distinguish a finger from a stylus.

An object of the present invention is to propose a method for characterizing an object of interest (used as control object), that is, to obtain additional information beyond its simple location in space.

Another object of the present invention is to propose a method for determining the angular position of an object of interest.

Another object of the present invention is to propose a method for determining a dimension of an object of interest.

Another object of the present invention is to propose a method allowing the nature of an object of interest to be identified, in such a way for example as to distinguish a finger from a stylus.

### DISCLOSURE OF THE INVENTION

This objective is achieved with a method for characterizing an object of interest in interaction with a measurement interface, comprising the steps of:
acquisition of a spatial distribution of measurements representative of the distance between the object of interest and a plurality of measurement points of the measurement interface,
determination of an estimated position of the object of interest relative to the measurement interface from said spatial distribution of measurements,
characterized in that it further comprises a step of determining at least one additional characteristic of the object of interest between a dimensional characteristic and a characteristic of angular position relative to the measurement interface, by using a function taking into account said estimated position and said spatial distribution of measurements.

The measurements representative of the distance can comprise any type of measurements allowing deduction of information of distance between the object of interest and the measurement interface. In particular, this information can comprise:
measurements of distances;
measurements of physical size variable with the distance, and/or enabling distance to be deduced. For example, this can involve measurements of an electrical capacitance between the object of interest and sensors.

The spatial distribution of measurements can correspond to a set of measurements P(x, y) that are representative of the distance between the object of interest and a plurality of measurement points tied to a reference surface of the measurement interface. Said measurement points can correspond for example to positions of coordinates (x, y) in a reference system (in plain or curvilinear coordinates) associated with a reference surface of the measurement interface. The distances between the object of interest and the measurement points can be estimated along directions substantially perpendicular to said reference surface at the point of measurement.

The reference surface can be plane. It can also be locally approximated by a plane. The reference surface can then be considered, without loss of generality, to be a plane of reference.

The estimated position of the object of interest can be obtained by using any method known to a person skilled in the art. Its determination can for example comprise:
a calculation of center of gravity or of centroid of the spatial distribution of measurements,
a weighted average of said distribution,
search for a local extremum of said distribution (such as the point of the object of interest closest to the reference surface),
a deconvolution of the spatial distribution of measurements by an impulse response (from the object, sensors), etc.

In general, said estimated position can comprise a point of coordinates (x_{c}, y_{c}) in the reference surface of the measurement interface.

Said estimated position can also comprise an estimated distance P_{c}(x_{c}, y_{c}) of the object of interest relative to the reference surface of the measurement interface, also deduced from the spatial distribution of measurements of distances.

The function taking into account the estimated position of the spatial distribution of measurements can be a function allowing an analysis to be made of the spatial distribution of measurements that is centered on the estimated position and/or according to a circular symmetry with respect to the estimated position.

Depending on the modes of implementation, the method according to the invention can comprise a step of determining an additional characteristic of the object of interest, which is a characteristic of angular position relative to the measurement interface.

The method according to the invention can then comprise the determination of at least one coefficient of asymmetry representative of the angular position of the object of interest relative to a reference surface of the measurement interface, comprising a step of projection of the spatial distribution of measurements on the at least one basic harmonic function at circular coordinates defined on said reference surface and centered on the estimated position of the object of interest within said reference surface.

The at least one basic function can comprise:
a complex exponential function the argument of which comprises a term corresponding to an angular orientation relative to the center of said basic function;
a containment term tending towards zero when moving away from its center.

The complex exponential function can of course be expressed in the form of trigonometric functions corresponding to its projection on real and imaginary axes.

The at least one basic function can also comprise a product of the following terms:
a containment term A(rₒ), where rₒ is a distance with respect to the center of said basic function, and
a complex exponential term e^{-inθ}^{₀}, where i is the imaginary unit, n is a whole number and θ₀ corresponds to an angular orientation relative to the center of said basic function.

The method according to the invention can further comprise the steps of:
calculation of a scalar product between the spatial distribution of measurements and the at least one basic function, and
determination of the coefficient of asymmetry from said scalar product.

The scalar product can be calculated in a plurality of measurement points located at equal distance from the estimated position of the object of interest.

Said points can constitute a circle in the reference surface centered on the estimated position of the object of interest. They can be angularly distributed in a way that is substantially uniform.

The scalar product can also be calculated in a plurality of points distributed according to a plurality of concentric circles in the reference surface, centered on the estimated position of the object of interest.

The method according to the invention can further comprise at least one of the following steps:
a determination of an angular orientation of the object of interest in the reference surface of the measurement interface by using the argument of the coefficient of asymmetry,
a determination of an angle of incidence of the object of interest relative to said reference surface of the measurement interface by using the modulus of the coefficient of asymmetry.

Depending on the embodiments, the method according to the invention can further comprise the steps of:
determination of calibration relationships between coefficient of asymmetry values and values of angular orientation and/or angle of incidence obtained from calibration measurements performed with a reference object, and
utilization of said calibration relationships to calculate the angular orientation and/or the angle of incidence of the object of interest from the coefficient of asymmetry.

Depending on the implementations, the method according to the invention can comprise a step of determining an additional characteristic of the object of interest, which is a dimensional characteristic of said object of interest.

The method according to the invention can then comprise the determination of a coefficient of size representative of a dimension of the object of interest, comprising the steps of:
determination of at least one minimal value of the spatial distribution of measurements in at least one set of measurement points situated at equal distance from the estimated position of the object of interest,
comparison of said minimal value(s) with the value of the spatial distribution of measurements at the estimated position of the object of interest.

Said dimensional characteristic or said dimension can be representative of a transverse dimension of the object of interest, such as a cross-section or a diameter.

The method according to the invention can further comprise:
a step of calculating an average minimal value corresponding to a weighted average of a plurality of minimal values of the spatial distribution of measurements determined at different distances from the estimated position of the object of interest with coefficients of weighting that are constant or decreasing with said distances.
a step of calculating a difference between a minimal value or an average minimal value and the value of the spatial distribution of measurements to the estimated position of the object of interest.

Depending on embodiments, the method according to the invention can further comprise the steps of:
determination of calibration relationships between coefficients of size and the section of an object of interest, obtained from calibration measurements performed with a reference object,
utilization of said calibration relationships to calculate the section of the object of interest from the coefficient of size.

Depending on embodiments, the method according to the invention can further comprise a step of identifying the object of interest among a set of known objects by using the coefficient of size.

Said set of known objects can for example comprise a finger and a stylus.

In particular, the method according to the invention can further comprise a step of determining whether the object of interest corresponds to a stylus.

The method according to the invention can further comprise a step of calculating an aimpoint in the projection of the object of interest onto the measurement interface, by exploiting a previously determined characteristic of angular position of the object of interest.

This, for example, makes it possible to improve the accuracy with which a user can designate a point with his finger on a measurement or control interface, in particular when the finger is sharply angled with respect to the surface. Under these conditions, because of the shape and thickness of the finger, the position estimated from the spatial distribution of measurements of distances is located within a zone beneath the finger, therefore invisible for the user. Conversely, the aimpoint calculated with the method of the invention is within the extension of the finger, and corresponds to the zone that the user designates.

The step of calculating an aimpoint can be performed only when a previously calculated dimensional characteristic of the object of interest fulfills a predetermined condition with respect to a threshold value.

Said predetermined condition can be that the previously calculated dimensional characteristic of the object of interest is greater than a threshold value.

In this case, the step of calculating an aimpoint is only performed for rather large objects of interest (for example fingers) that mask the surface of the measurement interface and make pointing difficult. Conversely, if the user approaches a stylus (thinner than a finger, therefore with a dimensional characteristic smaller than a threshold value, making it possible for example to distinguish a stylus from a finger) to the measurement interface, the point of the stylus does not mask the estimated position from the spatial distribution of distance measurements and it is considered unnecessary to calculate an aimpoint.

Said predetermined condition can also be that the previously calculated dimensional characteristic of the object of interest is less than a threshold value.

In this case, the step of calculating an aimpoint is only performed for rather thin objects of interest, such as styluses. Thus the ease-of-use can be improved for precise applications such as writing or drawing.

More generally, depending on the modes of implementation, the method according to the invention can comprise:
the determination of only one of two characteristics: dimensional or angular position;
the determination of two characteristics: dimensional and angular position;
the determination of a first characteristic, and depending on criteria applied to said first characteristic, the determination of the second characteristic.

For example a determination of a dimensional characteristic can make it possible to determine whether the object of interest is a finger or a stylus (of smaller cross-section than a finger).

Then several specific cases can result, in particular:
it can be decided to determine the characteristic of angular position only if the object of interest is a finger, for example in order to calculate an aimpoint;
it can be decided to determine the characteristic of angular position only if the object of interest is a stylus, for example in order to adjust styles or thicknesses of lines in drawing or writing applications;
it can be decided to determine the characteristic of angular position in both cases, and possibly to use it in a different way.

According to another aspect of the invention, an interface device is proposed comprising:
a measurement interface,
a plurality of sensors capable of producing information of distance between at least one object of interest and a plurality of measurement points of said measurement interface, in such a way as to produce a spatial distribution of measurements, and
calculation means capable of allowing a characterization of the object of interest according to the method of any one of the preceding claims.

The interface device according to the invention can comprise capacitive sensors distributed according to a matrix of points on the measurement interface.

Said device can comprise capacitive sensors and a measurement interface that are substantially transparent.

According to another aspect of the invention, an apparatus of one of the following types is proposed: computer, telephone, smart phone, tablet, display screen, terminal, comprising an interface device according to the invention.

### DESCRIPTION OF THE FIGURES AND EMBODIMENTS

Other advantages and features of the invention will be seen from the following detailed description of non-limiting implementations and embodiments, with reference to the appended drawings in which:

FIG. 1 illustrates a cross-sectional view of a measurement interface implementing the method according to the invention,

FIG. 2 illustrates one example of embodiment of capacitive detection electronics in a measurement interface implementing the method according to the invention,

FIGS. 3(a)-3(c) illustrate a top view of a measurement interface implementing the method according to the invention, the spatial distributions of measurements representative of the distance between an object of interest and said measurement interface for, respectively, FIG. 3(a) an object perpendicular to the measurement interface, FIG. 3(b) a slightly angled object, and FIG. 3(c) a sharply angled object.

A non-limiting example of embodiment of a capacitive measurement interface will now be described, used as control interface and adapted to the implementation of the method according to the invention.

In particular, such a measurement interface is adapted to the production of tactile and contactless control interfaces, or man-machine interfaces, for systems or apparatuses such as portable telephones (smart phones), tablets, computers or control pads.

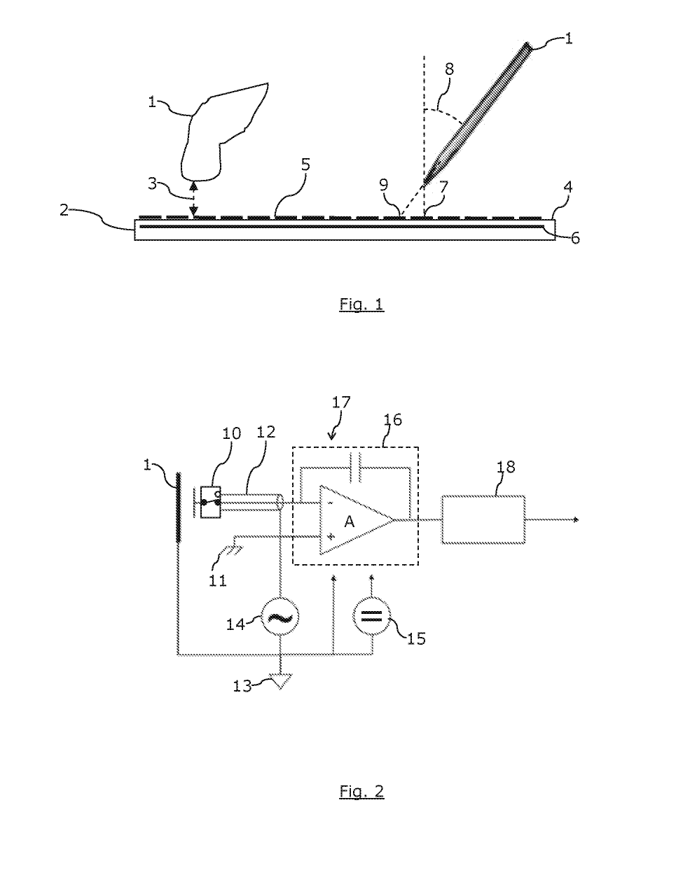

With reference to FIG. 1, the measurement interface 2 comprises a detection surface 4 provided with capacitive measurement electrodes 5.

In the embodiment shown, the detection surface 4 is a plane surface. It can be considered, with no loss of generality, that said detection surface 4 constitutes the reference surface, or the plane of reference, of the measurement interface 2.

The measurement electrodes 5 are produced from a substantially transparent conductive material, such as for example ITO (indium-tin oxide) deposited on a dielectric material (glass or polymer). They are superimposed on a display screen, for example of the TFT type (thin-film transistor) or OLED (organic light emitting diodes).

The measurement electrodes 5 can detect the presence and/or the distance of at least one object of interest 1, which is also a control object 1, in a measurement zone. Preferably, the measurement electrodes 5 and their associated electronics are configured in such a way as to allow simultaneous detection of a plurality of objects 1.

The position of the object 1 or objects 1 on the detection surface 4 is determined from the position (on said detection surface 4) of the measurement electrodes 5 which detect the objects 1.

The distance 3, or at least information representative of the distance 3, between the objects 1 and the detection surface is determined from the capacitive coupling measurements between the electrodes 5 and the objects 1.

One or more guard electrodes 6 are positioned along the rear face of the measurement electrodes 5, relative to the detection zone of the objects 1. They are also produced from a substantially transparent conductive material, such as for example ITO (indium-tin oxide), and are separated from the measurement electrodes 5 by a layer of dielectric material.

With reference to FIG. 2, the measurement electrodes 5 are connected to electronic capacitive measuring means 17.

Said electronic capacitive measuring means 17, in the embodiment of FIG. 2, are produced in the form of a floating bridge capacitive measuring system as described for example in the document FR 2 756 048 of Rozière.

The detection circuit comprises a so-called floating part 16 the reference potential 11 of which, called guard potential 11, oscillates with respect to the mass 13 of the overall system, or to ground. The difference of alternating potential between the guard potential 11 and the mass 13 is generated by an excitation source, or an oscillator 14.

The guard electrodes 6 are connected to the guard potential 11.

The floating part 16 comprises the sensitive part of the capacitive detection, represented in FIG. 2 by a load amplifier. Of course, it can comprise other means of processing and conditioning the signal, including digital or microprocessor-based, equally referenced to the guard potential 11. Said processing and conditioning means make it possible, for example, to calculate distance and pressure information from capacitive measurements.

The electrical power supply of the floating part 16 is provided by floating power supply transfer means 15, comprising for example DC/DC converters.

Said capacitive measuring system enables information about capacitance between at least one measurement electrode 5 and a control object 1 to be measured.

The control object 1 should be connected to a different potential than the guard potential 11, such as for example the mass potential 13. This is the configuration when the control object 1 is a finger of the user whose body defines a mass, or an object (such as a stylus) manipulated by said user.

A set of analog switches 10, controlled by electronic control means, allows a measurement electrode 5 to be selected and to be connected to the capacitive detection electronics 17 in order to measure the coupling capacitance with the object 1. The switches 10 are configured in such a way that a measurement electrode 5 is connected either to the capacitive detection electronics 17, or to the guard potential 11.

The sensitive part of the detection is protected by guard shielding 12 connected to the guard potential 11.

Thus, a measurement electrode 5 connected by a switch 10 to the capacitive detection electronics 17 (or active measurement electrode 5) is surrounded by guard planes consisting at least in part by inactive measurement electrodes 5 and by guard electrodes 6 connected to the guard potential 11.

Since the active measurement electrode 5 is also at the guard potential 11, the appearance of parasitic capacitances is thus avoided between said electrode and its environment, so that only the coupling with the object of interest is measured with maximum sensitivity.

The output of the floating electronics 16 is connected to the electronics of system 18 referenced to the mass by electrical connections compatible with the difference of reference potentials. Said connections can comprise for example differential amplifiers or opto-couplers.

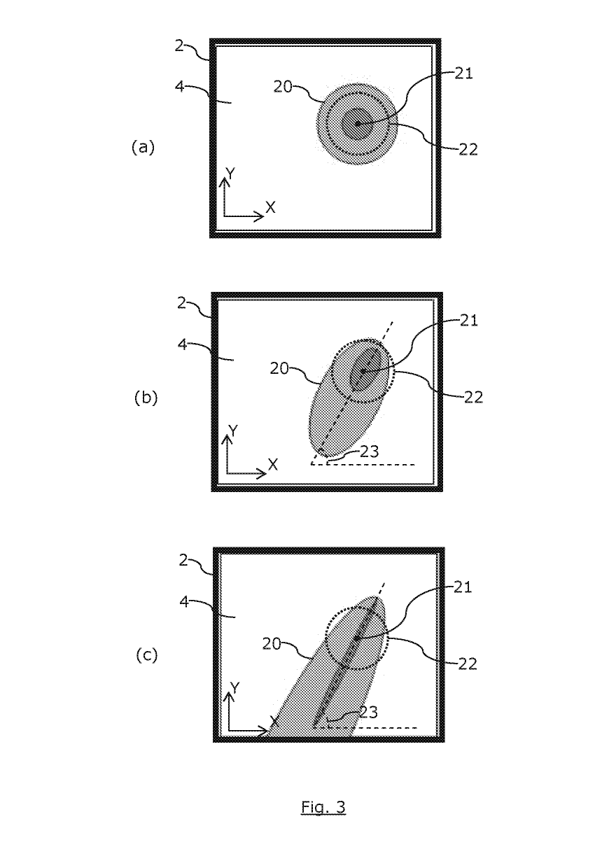

With reference to FIG. 3(a)-(c), when an object of interest 1 approaches the measuring interface 4, a capacitive coupling is established between said object 1 and the measurement electrodes 5 that depends on the distance 3 separating them, and therefore on the respective positions of the electrodes 5 on the detection surface 4. Thus the spatial distribution of measurements 20 is obtained that is representative of the distance between the object of interest 1 and a plurality of measurement points of the measurement interface 2. Said measurement points correspond, in the embodiment shown, to the position of the electrodes 5 on the detection surface 4.

The spatial distribution of measurements 20 allows the object 1 to be located relative to the detection surface 4.

According to advantageous aspects of the invention, said spatial distribution of measurements 20 also enables information to be obtained about:
dimensional characteristics of the object 1, such as its section;
the angular position of the object 1 relative to the measurement interface 2 or to the detection surface 4.

The angular position of the object 1 relative to the measurement interface 2 can be described in particular by:
an angle of incidence 8, defined for example between the object 1 and a line perpendicular to the detection surface 4, as illustrated in FIG. 1;
an angular orientation 23 of the projection of said object 1 onto the detection surface 4 (with respect for example to an axis of a system of coordinates associated with said surface).

FIGS. 3(a)-(c) illustrate examples of spatial distributions of measurements 20 obtained for elongated rectilinear objects 1 (such as styluses or fingers), for different angles of incidence 8:
FIG. 3(a) illustrates a spatial distribution of measurements 20 obtained when the object 1 is positioned substantially perpendicular to the detection surface 4, or with an angle of incidence 8 close to zero. In this case, the spatial distribution of measurements 20 has an essentially circular form;
FIG. 3(b) illustrates a spatial distribution of measurements 20 obtained when the object 1 is positioned with a low angle of incidence 8. In this case, the spatial distribution of measurements 20 has a form that is substantially elongated along an axis corresponding to the angular orientation 23 of the object 1;
FIG. 3(c) illustrates a spatial distribution of measurements 20 obtained when the object 1 is positioned with a high angle of incidence 8. The elongation is more pronounced. FIG. 3(c) further illustrates a case in which the spatial distribution of measurements 20 is truncated by the limited area of the detection surface 4.

As previously explained, the detection surface 4 is considered as a plane of reference 4, and a system of coordinates (X, Y) is associated with it.

The method according to the invention will now be described in detail.

First, from raw measurements produced by sensors 5, at least one spatial distribution of measurements 20 is determined, corresponding to at least one object of interest 1.

In a case where a plurality of object of interest 1 are detected simultaneously, the measurements can be segmented into a plurality of spatial distributions of measurements 20, for example by thresholding of distance measurements. Said spatial distributions of measurements 20 can then be processed independently.

A spatial distribution of measurements 20 is noted P(x, y), where x and y are the coordinates of the corresponding measurement points in the plane of reference 4.

An estimated position 21 is then determined of the object of interest in the plane of reference 4. Said estimated position 21 corresponds to a point of coordinates (x_{c}, y_{c}) in the plane of reference 4.

The simplest way to do this is to determine the point 7 corresponding to a local minimum distance in the spatial distribution of measurement 20.

To improve the accuracy, the barycenter or center of gravity of the spatial distribution of measurement 20 can also be calculated, taken in its totality or in the vicinity of a previously determined local minimum, by assigning a weight corresponding to the distance P(x, y) to each point (x, y) considered.

### Angular Position

A first aspect of the invention will now be described, which concerns the determination of the angular position of the object 1 relative to the measurement interface 2.

To that end, a measurement is made of the asymmetry of the spatial distribution of measurements 20. The angular orientation 23 can then be equated to a preferred direction of said asymmetry, and the angle of incidence 8 as a level of asymmetry.

The measurement of the asymmetry is performed by calculating a projection of the spatial distribution of measurements 20 on at least one base function defined in the plane of reference 4, in order to determine a coefficient of asymmetry. Generally, said coefficient of asymmetry is complex.

The base functions used for this projection are generally in the following form:

Fₙ(r₀, θ₀)=A(r₀)e^{-inθ}^{₀}, (Eq. 1)

The variables are defined as follows:
r₀ is the distance between the coordinates point (x, y) and the estimated position of the object 1 (x_{c}, y_{c}):

r₀=\sqrt{x₀²+y₀²}; (Eq. 2)
θ₀ is the direction or angular orientation of the coordinates point (x, y) relative to the estimated position of the object 1 (x_{c}, y_{c}):

θ₀=a tan 2(x₀, y₀); (Eq. 3)
(x₀, y₀) are the coordinates relative to the estimated position (x_{c}, y_{c}) of the object 1 in the plane of reference 4:

x₀=x−xc,

y₀=y−yc;
i is the imaginary unit (i²=−1);
n is a whole number.

The radial term A(r₀) is a containment term which tends towards zero or which cancels out at least for distances r₀ greater than a limiting distance (with respect to the estimated position 21 of the object 1).

Said limiting distance can correspond, for example, to the width of the zone affected by the presence of the object of interest 1, or of a zone where the distance measurements are considered as significant.

In practice, said term A(r₀) is chosen as non-nil for certain points corresponding to certain values of r₀ around the estimated position 21 of the object 1, or in the vicinity of said estimated position 21, and nil elsewhere.

Said chosen base functions Fₙ(r₀,θ₀) are therefore harmonic functions at circular coordinates (r,θ).

To calculate the projection of the spatial distribution of measurements 20 on a base function Fₙ and thus determine the coefficient of asymmetry Zₙ, a normalized scalar product is calculated of said spatial distribution of measurement P and of the chosen base function Fₙ:

Zₙ=ΣⱼP(xⱼ, yⱼ) Fₙ(xⱼ, yⱼ, x_{c}, y_{c})/Σⱼ|F₀(xⱼ, yⱼ, x_{c}, y_{c})|². (Eq. 5)

Said coefficient of asymmetry Zn is calculated on a set of points (xⱼ, yⱼ) around the estimated position 21 of the object 1:
it can be calculated for example in a vicinity of respectively Nₓ points along the X axis and N_{y} points along the Y axis, in which case j=1 . . . NₓN_{y};
it can also be calculated on a more restricted and judiciously selected number of points in order to optimize the calculation time.

The term at the denominator of the coefficient of asymmetry Zₙ is a normalization term. F₀ is a base function calculated with n=0, which therefore does not depend on θ₀.

The projection of the spatial distribution of measurements 20 on a base function F₁, that is, Fₙ with n=1, has particularly advantageous properties. Indeed, a coefficient of asymmetry Z₁ is obtained in which:
the angle or the argument is representative of the preferential direction of the spatial distribution of measurements 20, and therefore furnishes information about the angular orientation of the object of interest 1 in the plane of reference 4;
the modulus is representative of the degree of asymmetry of the spatial distribution of measurements 20, and therefore ultimately furnishes information about the angle of incidence of the finger.

It is then necessary to construct a relationship of passage between the coefficient of asymmetry Z₁ and the characteristics of angular position of the object of interest 1, such as its angular orientation 23 and its angle of incidence 8.

Indeed:
the angle or argument of coefficient of asymmetry Z₁ theoretically corresponds to the angular orientation 23 of the object of interest 1, but it can be affected by errors due for example to the edge effects if the object of interest 1 is close to the edge of the detection surface 4, or to homogeneity defects of the sensors 5;
the modulus of the coefficient of asymmetry Z₁ furnishes an indirect indication about the angle of incidence 8.

In practice, said relation of passage is obtained by calibration.

In a prior step, measurements are made with at least one reference object for a set of points of the detection surface 4, and for a set of representative angular positions. The coefficient of asymmetry Z₁ is also calculated.

Deduced therefrom are relationships that allow an angular orientation 23 and an angle of incidence 8 of an object of interest 1 to be calculated from the coefficient of asymmetry Z₁ and from the estimated position 21. Said relationships can be implemented for example in a polynomial form, or in the form of lookup tables.

In a preferred embodiment, the coefficient of asymmetry Z₁ is calculated (for n=1) on a set of points that form a calculation circle 22 of radius r_{d} the center of which corresponds to the estimated position 21. Said points are distributed over the entirety of the circle, over 360° of angle, so as to form a plurality of radial directions {θ_{d}}. For example, 12 radial directions can be used spaced at 30° of angle. In this way calculations can be performed very quickly.

To the extent in which a restricted number of always identical radial directions is used, it is possible to calculate the angular term e^{-iθ}^{₀} of the base function F₁ only one time, for example during an initialization phase, and to store it in memory for subsequent use.

The radial term A(r₀) of the base function F₁ is non-nil and constant (for example equal to 1) for the points located on the calculation circle 22 of radius r_{d}, and nil elsewhere.

In practice, therefore, the coefficient of asymmetry Z₁ is calculated according to Eq. 5 on a set of points (xⱼ, yⱼ) such that:

\sqrt{(xⱼ−x_{c})²+(yⱼ−y_{c})²}=r_{d},

and

a tan 2(xⱼ−x_{c}, yⱼ−y_{c})=θ_{d}. (Eq. 6)

The function a tan 2 designates the tangent arc calculated over 360°.

In the preferred embodiment, the normalization term at the denominator of the coefficient of asymmetry Z₁ (Eq. 5) is replaced by an approximate expression that depends on the measurement of distance P(x_{c},y_{c}) to the estimated position 21 of the object 1. Said normalization term is calculated from measurements from sensors 5 in such a way that the measurement of angle of incidence 8 gives an estimation that tends towards an indication of normal incidence (therefore an angle of incidence 8 which tends towards zero) when the object of interest is going away from the detection surface 4 at the point which the signal producing the distance measurement becomes too week to be determined accurately. This makes it possible to improve the stability and coherence of information furnished to graphic interface controls which exploit said information.

According to variants of embodiments,
to improve the quality of measurements on the edges of the detection surface 4, the spatial distribution of measurements 20 can be supplemented by extrapolation beyond said detection surface 4;
information furnished by coefficients of asymmetry Zₙ calculated for n>1 can be exploited in order, for example, to distinguish spatial distributions of measurements 20 emanating from different objects 1, or to contribute additional accuracy in the estimation of the angular orientation 23 of the distribution 20;
the information related to the distance P to the estimated position 21 can be exploited in order to adapt the calculation of the angle of incidence 8 based on the actual performance of the signal. Thus, an a priori noise model can be created leading to a conventional asymptotic behavior (for example an angle of incidence 8 set at zero) in the regions where the determination is affected by significant uncertainties (for example when an object of interest 1 is at a great distance from the detection surface 4). This can make it possible to facilitate the exploitation of this information by the software that then manages the controls;
the radius r_{d} of the calculation circle can be determined dynamically as a function of the spatial distribution of measurements 20, for example based on its spread or on measured distances;
the coefficient of asymmetry Z₁ or the coefficients of asymmetry Zₙ can generally be calculated on a set of points corresponding to a calculation circle 22, or to a plurality of concentric calculation circles 22 of different radii;
the angle of incidence 8 and the distance P(x_{c}, y_{c}) at the estimated position 21 of the object 1 on the detection surface 4 (which generally corresponds to the projection 7 of the end of the object 1), can be utilized to calculate an aimpoint 9 in the extension of the object of interest onto the detection surface 4.

### Dimensional Characteristic

A second aspect of the invention will now be described, concerning the determination of dimensional characteristics of the object 1, such as its cross-section or its diameter.

To that end, the spatial distribution of measurements 20 is used, and the estimated position 21 of the object of interest, of coordinates (x_{c}, y_{c}), is determined.

A set of points is then selected that form a calculation circle 22 with the radius r_{t,1}, or a plurality of different concentric calculation circles 22 (that is, K circles) of radii {r_{t,k;}k=1 . . . K}, and the center(s) of which correspond to the estimated position 21 (x_{c}, y_{c}).

Said points are distributed over the entirety of the circle(s), over 360° of angle, in a plurality of radial directions {(θ_{t,l}; l=1 . . . L} relative to the center (x_{c}, y_{c}). For example L=12 radial directions can be used spaced at 30° of angle.

Thus a set of points is obtained (x_{k,l}, y_{k,l}) such that:

\sqrt{(x_{k,l}−x_{c})²+(y_{k,l}−y_{c})²}=r_{t,k},

and

a tan 2(x_{k,l}−x_{c}, y_{k,l}−y_{c})=θ_{t,l}. (Eq. 7)

A size coefficient can then be calculated:

T=ΣₖB(k) minⱼ (P(x_{k,l}, y_{k,l}))−P(x_{c},y_{c}), (Eq. 8)

The operator minⱼ is the minimum operator. It returns the minimum value of the spatial distribution of measurement 20 on the points of the calculation circle 22 with the radius r_{t,k}.

Said minimum value has the most probabilities of being found in a direction perpendicular to the direction of extension of the spatial distribution of measurement 20 when the object of interest 1 has a non-perpendicular angle of incidence 8. Thus, an estimation is obtained which depends slightly on the angle of incidence 8.

The term B(k) is a weighting term that makes it possible to determine an average of the minimum values of the spatial distribution of measurement 20 on a plurality of calculation circles 22, by attributing more or less weight to the values resulting from the different calculation circles 22. It can be constant or decreasing depending on the radius of the calculation circles 22. It is preferably normalized:

ΣₖB(k)=1 (Eq. 9)

The coefficient of size T enables the value of the spatial distribution measurement 20 at the estimated position 21 to be compared to the minimal values of said spatial distribution of measurement 20 that are obtained on the calculation circle(s) 22. The greater its value, the closer the object 1 is.

According to a preferred embodiment, only one calculation circle 22 is used.

In order to determine a diameter of object 1 or its nature (finger or stylus, for example) from the coefficient of size, it is generally necessary to perform a calibration.

In a prior step, measurements are performed with a plurality of reference objects with different characteristics. Moreover, said measurements can be performed for a set of points of the detection surface 4 in order to correct non-homogeneities and/or edge effects. The coefficient of size T is also calculated.

Deduced therefrom our relationships that make it possible to determine a dimension or a nature of object 1 from the coefficient of size T and possibly of the estimated position 21. Said relationships can be implemented for example in a polynomial form, or in the form of lookup tables.

Depending on embodiments, the characteristics of angular position and the dimensional characteristics of the object of interest 1 can be determined independently, simultaneously or conditionally.

Moreover, it is possible to pool a large number of operations, such as:
determination of the estimated position 21;
determination of the points of one or more calculation circles 22: indeed, it is possible to utilize the same points to determine the angular position characteristics and the dimensional characteristics of the object of interest 1.

Depending on the embodiments, it is possible to perform a single calibration that can be used to determine the angular position characteristics and dimensional characteristics of the object of interest 1.

Of course, the invention is not limited to the examples that have just been described, and numerous adjustments can be made to these examples without going beyond the scope of the invention.

1. A method for characterizing an object of interest in interaction with a measurement interface, comprising:
acquisition of a spatial distribution of measurements representative of the distance between the object of interest and a plurality of measurement points of the measurement interface,
determination of an estimated position of the object of interest relative to the measurement interface from said spatial distribution of measurements, and
determining determination of at least one additional characteristic of the object of interest between a dimensional characteristic and a characteristic of angular position relative to the measurement interface, by using a function taking into account said estimated position and said spatial distribution of measurements.

2. The method of claim 1, further comprising determination of at least one coefficient of asymmetry representative of the angular position of the object of interest relative to a reference surface of the measurement interface, comprising a step of projection of the spatial distribution of measurements onto the at least one basic harmonic function at circular coordinates defined on said reference surface and centered on the estimated position of the object of interest within said reference surface.

3. The method of claim 2, wherein the at least one basic function comprises a complex exponential function the argument of which comprises a term corresponding to an angular orientation relative to the center of said basic function.

4. The method of claim 3, wherein the at least one basic function further comprises a containment term tending towards zero when moving away from its center.

5. The method of claim 2, wherein the at least one basic function comprises a product of the following terms:
a containment term A(r₀), where r₀ is a distance with respect to the center of said basic function, and
a complex exponential term e^{-inθ}^{₀}, where i is the imaginary unit, n is a whole number and θ₀ corresponds to an angular orientation relative to the center of said basic function.

6. The method according to claim 2, further comprising:
calculation of a scalar product between the spatial distribution of measurements and the at least one basic function, and
determination of the coefficient of asymmetry from said scalar product.

7. The method of claim 6, wherein the scalar product is calculated in a plurality of measurement points located at equal distance from the estimated position of the object of interest.

8. The method of claim 2, further comprising at least one of:
a determination of an angular orientation of the object of interest in the reference surface of the measurement interface by using the argument of the coefficient of asymmetry, and
a determination of an angle of incidence of the object of interest relative to said reference surface of the measurement interface by using the modulus of the coefficient of asymmetry.

9. The method of claim 2, further comprising:
determination of calibration relationships between coefficient of asymmetry values and values of angular orientation and/or angle of incidence obtained from calibration measurements performed with a reference object, and
utilization of said calibration relationships to calculate the angular orientation and/or the angle of incidence of the object of interest from the coefficient of asymmetry.

10. The method of claim 1, further comprising determination of a coefficient of size representative of a dimension of the object of interest, comprising:
determination of the at least one minimal value of the spatial distribution of measurements in at least one set of measurement points situated at equal distance from the estimated position of the object of interest,
comparison of said at least one minimal value with the value of the spatial distribution of measurements at the estimated position of the object of interest.

11. The method of claim 10, further comprising calculating an average minimal value corresponding to a weighted average of a plurality of minimal values of the spatial distribution of measurements determined at different distances from the estimated position of the object of interest with coefficients of weighting that are constant or decreasing with said distances.

12. The method of claim 11, further comprising calculating a difference between a minimal value or an average minimal value and the value of the spatial distribution of measurements to the estimated position of the object of interest.

13. The method of claim 10, further comprising:
determination of calibration relationships between coefficients of size and the section of an object of interest, obtained from calibration measurements performed with a reference object,
utilization of said calibration relationships to calculate the section of the object of interest from the coefficient of size.

14. The method of claim 10, further comprising identifying the object of interest among a set of known objects by using the coefficient of size.

15. The method of claim 14, further comprising determining whether the object of interest corresponds to a stylus.

16. The method of claim 1, which further comprises a step of further comprising calculating an aimpoint in the projection of the object of interest onto the measurement interface, by exploiting a previously determined characteristic of angular position of the object of interest.

17. The method of claim 16, wherein calculating an aimpoint is performed only when a previously calculated dimensional characteristic of the object of interest fulfills a predetermined condition with respect to a threshold value.

18. An interface device comprising:
a measurement interface,
a plurality of sensors capable of producing information of distance between at least one object of interest and a plurality of measurement points of said measurement interface, in such a way as to produce a spatial distribution of measurements, and
calculation means capable of enabling a characterization of the object of interest according to the method of any one of the preceding claims.

19. The interface device according to claim 18, further comprising capacitive sensors distributed according to a matrix of points on the measurement interface.

20. The interface device of claim 19, further comprising capacitive sensors and a measurement interface that are substantially transparent.

21. An apparatus of one of the following types: computer, telephone, smart phone, tablet, display screen, terminal, comprising an interface device according to claim 18.
